(19) United States
(12) Patent Application Publication
(10) Pub. No.: US 2009/0116405 A1
(43) Pub. Date: May 7, 2009

(54) Redundant Automation Data Communications Network

(75) Inventors: Antti Hakala-Ranta, Vaasa (FI); Tero Talvitie, Vaasa (FI); Kari Lappalainen, Jyvaskyla (FI); Heikki Bjorkman, Vaasa (FI)

Correspondence Address: BUCHANAN, INGERSOLL & ROONEY PC, POST OFFICE BOX 1404, ALEXANDRIA, VA, 22313-1404, US

(73) Assignee: ABB Oy, Helsinki (FI)

(21) Appl. No.: 11/988,002

(22) PCT Filed: Jun. 29, 2006
(86) PCT No.: PCT/FI2006/050298

§ 371 Date: Mar. 24, 2008

(30) Foreign Application Priority Data
Jun. 29, 2005 (FI) 20055363

(51) Int. Cl. H04L 12/28

(52) U.S. Cl. 370/254

(57) ABSTRACT

The object of the invention is an automation data communications network (3-1, 4-1) comprising a control and data acquisition device (3-2, 4-2), said device supporting a protocol for controlling communications within said network (3-1, 4-1), and one or more IEDs (4-8 . . . 4-16), said device supporting a protocol for controlling communications within said network (3-1, 4-1) and including a switch (4-8a) with at least two ports arranged in a functional connection with the device. The invention is characterized in that an element (4-6) with at least two ports is arranged in a functional connection with the control and data acquisition device (3-2, 4-2) and that a first loop is arranged between the IEDs (4-8 . . . 4-16) and a second loop is arranged between the IEDs (4-8 . . . 4-16) and the control and data acquisition device (3-2, 4-2).

### FIELD OF TECHNOLOGY

The invention relates to an automation data communications network, particularly to making such a network redundant.

### BACKGROUND OF THE INVENTION

FIG. 1 illustrates a simple conventional automation data communications network consisting of a star connection. The connection includes one station switch 1-2 and a number of bay switches 1-12. Each bay switch B1 . . . B6 allows the connection of one or more IEDs (Intelligent Electronic Devices) 1-14 . . . 1-24, such as protection relays. Furthermore, servers 1-4, 1-6, a COM gateway 1-8 and a time synchronization device (NTP, Network Time Protocol) 1-10 can be connected to the station switch. In FIG. 1 the bay switches are connected into a star arrangement.

A simple redundant network can be created by changing the star arrangement into a loop in accordance with FIG. 2. In this arrangement the servers 2-4, 2-6, the COM device 2-8 and the NTP device 2-10 are connected to the station switch 2-2. A number of bay switches 2-12 are also connected to the station switch in a loop arrangement. Similar to FIG. 1, the loop model allows one or more IEDs 2-14 . . . 2-24 to be connected to each bay switch. FIG. 2 shows that the arrangement provides bay level redundancy but the connection between the IEDs and the bay switches remains non-redundant. This means that failure of a single bay switch breaks the connection to all devices located subordinate to that switch.

If redundancy is desired at the IED level, each IED must be connected to two switches. This is accomplished by equipping each IED with two Ethernet interfaces and connecting it to two different switches. Therefore, each device must contain two Ethernet ports for connecting the device to an Ethernet LAN, and two separate switches are required for connecting the device. The number of bay switches required to connect the same number of IEDs to the network will be doubled at worst. However, if a single bay switch fails, communication to all IEDs will be operational through the other switch.

Document “Redundancy Process with Hirschmann Switches” Product analysis, Hiper ring vs. RSTP, XP 002407110 discloses a product test that is designed to analyze whether Ethernet switch systems are suitable for industry environments systems. Redundancy process include RSTP (Rapid Spanning Tree Protocol), Hirschmann process, dual homing, Hiper ring coupling and HiRRP (Hirschmann Router Redundancy Protocol).

Document Moxa Networking: “Redundancy in Automation”, Whitepaper, XP 002407109 discloses tests for redundancy in automation. It include power redundancy, media redundancy, network node redundancy, network redundancy and complete system redundancy.

However, the problem with the prior art solutions described above is that switches are always used to connect devices to the Ethernet network. Ethernet switches intended for industrial use are substantially expensive, and a single switch only allows the connection of a few devices. For example, two 8-port Ethernet switches can accommodate 14 devices in a star arrangement but only 6 devices in a redundant network. Thus the connection of 30 IEDs, for example, will require six 8-port switches in a star arrangement and as many as twelve switches in a redundant network. This causes substantial extra costs in a situation where redundancy is an absolute requirement.

### BRIEF DESCRIPTION OF THE INVENTION

The objective of the invention is to develop a method and an apparatus implementing the method in order to solve the problems referred to above. The objective of the invention will be accomplished by a method and system characterized by the independent claims. The dependent claims describe preferred embodiments of the invention.

The invention is based on arranging at least two loops between the IEDs and/or the IED control and data acquisition device, and providing an internal switch feature within the IED. This allows the IED to be connected to the Ethernet network without separate Ethernet switches. Furthermore, the Spanning Tree Protocol (STP) or the Rapid Spanning Tree Protocol (RSTP) can be provided in the device.

The advantage of a method and system according to the invention is that an inexpensive redundant automation data communications network can be implemented completely without separate Ethernet switches.

### BRIEF DESCRIPTION OF THE DRAWINGS

In the following the invention will be described in more detail in connection with preferred embodiments by referring to the enclosed drawings, where

FIG. 1 illustrates a conventional automation data communications network;

FIG. 2 illustrates a redundant conventional automation data communications network;

FIG. 3 illustrates an integrated 2-port switch function as part of an IED according to the invention and one of its preferred embodiments; and

FIG. 4 illustrates an arrangement according to the invention and one of its preferred embodiments.

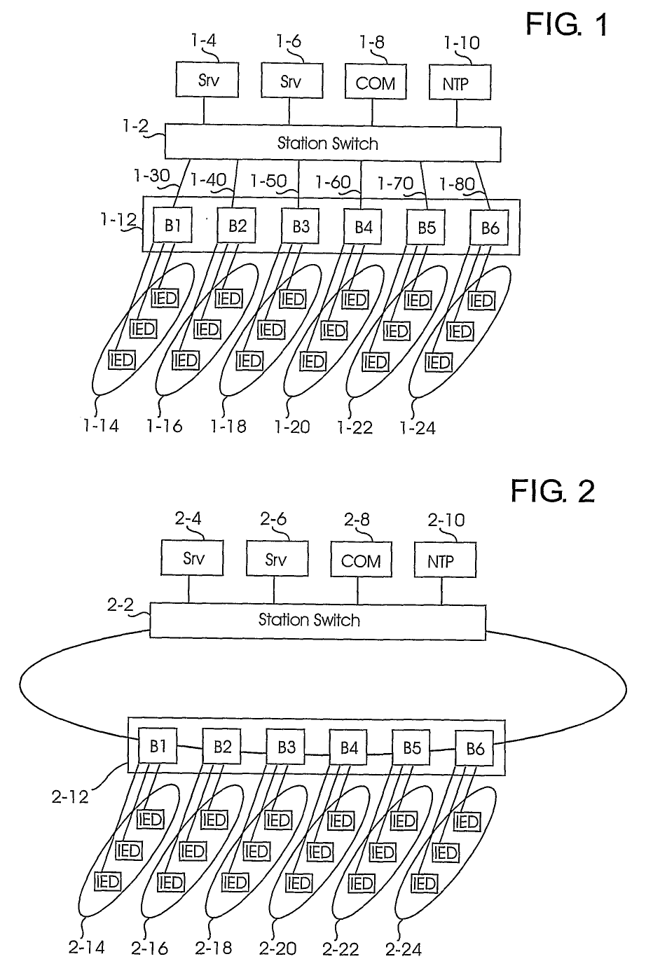

### DETAILED DESCRIPTION OF THE INVENTION

FIG. 4 illustrates an arrangement according to the invention and one of its preferred embodiments that creates a redundant automation data communications network. In this context redundancy can refer to the fact that information from a source such as an electric power network can be communicated from an IED through at least two alternate routes to a control and data acquisition device, such as a remote or local control room or a SCADA (Supervisory Control and Data Acquisition) device, which can be a computer or a relay for example. Redundancy can also refer to the fact that information can be communicated between IEDs through at least two alternate routes.

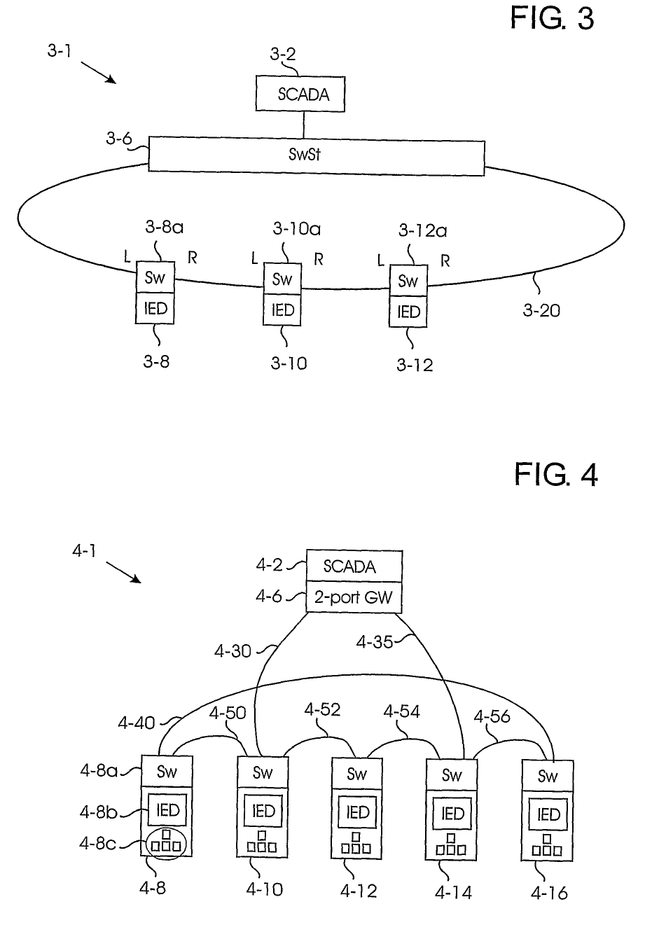

According to the invention and one of its preferred embodiments, the switch function for an IED can be integrated into the IED. This allows the creation of an alternative for a network comprising bay switches, and the IEDs can be daisy-chained as a simple loop connected to the station switch. This is illustrated in FIG. 3. In the figure the control and data acquisition device 3-2 is connected to an element 3-6, such as a station switch that can be a 3-port switch for example. Three IEDs 3-8, 3-10, 3-12 are connected to the station switch. Each IED block can have an integrated switch Sw with at least 2 ports designated L (Left) and R (Right). This allows communications to be routed from the left port of the first switch to the first IED, and from the right port to the left port of the switch within the second IED for example. As illustrated in FIG. 3, according to the invention and its preferred embodiments, said 2-port switch 3-8a, 3-10a, 3-12a can be integrated into the IED 3-8 . . . 3-12, and one or more IEDs 3-8 . . . 3-12 that can include an integrated 2-port switch and said at least 2-port element 3-6 can form a connection 3-20 arranged as a loop. The element 3-6 referred to in the above can be a 3-port switch 3-6 or a control and data acquisition device 3-2, 4-2. The procedure referred to in the above creates a redundant connection from the station switch to the IEDs, and any interruption between two IEDs can be compensated for as necessary. The failure of a single IED-specific switch or the failure of a single IED will only interrupt the connection to the failed device.

According to the invention and another of its preferred embodiments, an element with at least two ports, such as an Ethernet card 4-6, or two elements with at least one port, such as Ethernet cards, can be added to form a functional connection with the control and data acquisition device such as the SCADA device 4-2. This allows the elimination of the station switch 3-6 (FIG. 3), making the switch function a part of the SCADA system's Ethernet interface. Instead of an Ethernet interface, the element 4-6 can be a 2-port switch or a 2-port gateway element for example.

According to the invention and its preferred embodiments, one or more loops can be arranged between the IEDs 4-8 . . . 4-16, and/or one or more loops can be arranged between the IEDs 4-8 . . . 4-16 and the control and data acquisition device 3-2, 4-2. When creating a loop that includes a control and data acquisition device, at least two IEDs can be connected to the control and data acquisition device. Furthermore, devices such as IEDs can be connected to the control and data acquisition device so that they are not included in the loop.

According to FIG. 4, the SCADA can be connected 4-30, 4-35 redundantly to two 3-port switches integrated into IED blocks 4-10, 4-14. In this case the arrangement creates two loops between the IED blocks 4-8 . . . 4-16 and the SCADA device, and no separate switches are required in the network. For example, the network's first loop 4-40, 4-50 . . . 4-56 is created between all of the IEDs in the loop, the second loop 4-30, 4-52, 4-54, 4-35 is created between the SCADA device 4-2 and two or more IEDs 4-10, 4-12, 4-14, and the third loop 4-30, 4-50, 4-40, 4-56, 4-35 is created between the SCADA device 4-2 and two or more IEDs 4-10, 4-8, 4-16, 4-14.

Connections according to the above allow communication between IEDs through the station switch in case a loop internal to the instrumentation is broken. If the station switch is replaced by two separate Ethernet interfaces in the control and data acquisition device for example, the switch function enables communication between IEDs. This switch function between two Ethernet interfaces can be implemented in software for example.

Thus the SCADA device can be directly connected to two or more IEDs. This arrangement allows each IED in the redundant network to be connected to at least one other IED, and one or more IEDs to be additionally connected to the control and data acquisition device. Alternatively, the SCADA device can be connected to two IED blocks using two mutually independent Ethernet interfaces with no switch function and without creating a loop, while still providing a redundant connection from the IED blocks to the SCADA device.

The control and data acquisition device 4-2 can be connected to two IED blocks, meaning that the control and data acquisition device can be connected to the loop of IEDs using two connections so that the IED blocks connected to the control and data acquisition device are adjacent IED blocks, or at least one IED block that is not connected to the control and data acquisition device remains between the IED blocks.

An IED can also be referred to as an IED block. As shown in FIG. 4, each IED block 4-8 may comprise a switch 4-8a, an IED 4-8b and a user interface 4-8c.

The above only describes one potential connection arrangement, but it should be understood that connection arrangements could be implemented in several ways, fulfilling the condition that at least one IED can be equipped with a redundant connection to the SCADA device. Thus redundancy can be taken to the IED level, and a failure of a single IED only interrupts the connection to that particular device. Within the connection arrangements, connections can be permanent, meaning that they are active whenever there is no failure.

Switching reliability can also be increased by providing more connections to the station switch, for example a third or fourth connection.

According to the invention and its preferred embodiments, the SCADA element is not mandatory in the connection arrangements but can be replaced by an element such as an IED. Furthermore, a connection arrangement can be created in which the SCADA element is connected to only one IED and/or only the IEDs are in a loop and/or at least one loop is arranged between the IEDs and the control and data acquisition device.

The invention and its preferred embodiments provide a loop of IEDs and, optionally, an additional redundant SCADA connection.

According to yet another preferred embodiment of the invention, the devices connected to the redundant network can be equipped with a protocol that facilitates the control of communication in a looped network. For example, the protocol for the IEDs and the SCADA element can be chosen to support recovery from failures as quickly as possible and allow efficient reconfiguration of the network topology. The protocol can also be arranged to prevent the creation of functionally non-terminated loops. Examples of potentially supported protocols include the Spanning Tree Protocol (STP) and the Rapid Spanning Tree Protocol (RSTP).

One of the purposes of the invention and its preferred embodiments is the implementation of a redundant communications network without separate Ethernet switches. According to the invention and its preferred embodiments, an Ethernet switch and a redundant connection can be integrated as a part of the IED functionality, and devices can be directly daisy-chained with each other. This means that separate switches are not necessarily required in the network solutions for an electrical substation, and the number of switches can be substantially reduced. A switch is only required for devices with no integrated switch. To allow full-scale utilization of the invention and its preferred embodiments, one or more devices connected to the network should have a switch with at least 2 or 3 ports, integrated or non-integrated. Furthermore, as specified in the above, the devices must support a protocol referred to in the above, preferably the STP or RSTP protocol.

According to a preferred embodiment, a redundant automation data communications network can be implemented completely without separate Ethernet switches if the IEDs have an integrated switch feature and the devices implement the Spanning Tree Protocol (STP) or the Rapid Spanning Tree Protocol (RSTP). Support for said protocols allows the connection of commercial switches to the same automation network for example. It is also possible to use the Enhanced Rapid Spanning Tree Protocol, a further development of RSTP that can recover from a reconfiguration of network topology within a time as short as 5 ms. This will increase the security of a substation network, and for example, as connection interruptions become shorter.

An advantage of the invention and its preferred embodiments is that the automation data communications network will remain operational even if two IEDs fail or if a single IED and the station switch connection fail.

Another advantage of the invention and its preferred embodiments is that substantial cost savings are generated through the elimination of any separate industrial-duty Ethernet switches from the network.

It is obvious to a person skilled in the art that the progress of technology will allow the fundamental idea of the invention to be implemented in many different ways. Thus the invention and its embodiments are not limited to the examples described above but may vary within the scope of the claims.

1. An automation data communications network, comprising
a control and data acquisition device, said device supporting a protocol for controlling communications within said network;
one or more IED-devices (IED, Intelligent Electronic Device), said device supporting a protocol for controlling communications within said network and comprising a switch with at least two ports arranged in a functional connection with the device, wherein
an element with at least two ports is arranged in a functional connection with the control and data acquisition device; and that
a first loop is arranged between the IED-devices, and a second loop is arranged between the IED-devices and the control and data acquisition device.

2. A network according to claim 1, wherein the IED-devices are connected to each other in a loop arrangement and that the control and data acquisition device is directly connected (4-30, 4-35) to at least two IED-devices.

3. A network according to claim 1, wherein said element with at least two ports is integrated into the control and data acquisition device.

4. A network according to claim 1, wherein said element with at least two ports is replaced by an Ethernet card with at least two ports.

5. A network according to claim 1, wherein said switch with at least two ports is integrated into an IED.

6. A network according to claim 1, wherein said switch with at least two ports is replaced by an Ethernet card with at least two ports.

7. A network according to claim 1, wherein the protocol is arranged to prevent the creation of functionally non-terminated loops.

8. A network according to claim 7, wherein the protocol is the Spanning Tree Protocol or the Rapid Spanning Tree Protocol.

9. A network according to claim 1, wherein it further comprises one or more IED-devices adapted directly to the loop-shaped network and/or the control and data acquisition device using a switch.

10. A method for making an automation data communications network redundant, said method utilizing a protocol for controlling communications within said network, wherein at least two loops are created, the first loop between the IED-devices (IED, Intelligent Electronic Device) and the second loon between the IED-devices and a control and data acquisition device.

11. A device for an automation data communications network, said device being arranged to support a protocol for controlling communications within said network and a switch with at least two ports being arranged in a functional connection with said device, wherein the device is arranged to communicate with other similar devices through a first loop and in that the device is arranged to communicate with the a control and data acquisition device through a second loop.

12. A device for an automation data communications network, said device being arranged to support a protocol for controlling communications within said network and an element with at least two ports being arranged in a functional connection with said device, wherein the device is arranged to communicate with other devices in the automation data communications network through a first loop and a second loop.

13. An automation data communications network, comprising—an element with at least two ports;—one or more IED-devices (IED, Intelligent Electronic Device), said devices supporting a protocol for controlling communications 10 within said network, and a switch with at least two ports being arranged in a functional connection with said device, wherein said two-port switch is integrated into an IED and in that said one or more IED-devices and said element with at least two ports form a connection arranged as a loop.

14. A network according to claim 13, wherein said element is a three-port switch or a control and data acquisition device.

15. A network according to claim 2, wherein said element with at least two ports is integrated into the control and data acquisition device.

16. A network according to claim 3, wherein said element with at least two ports is replaced by an Ethernet card with at least two ports.

17. A network according to claim 4, wherein said switch with at least two ports is integrated into an IED.

18. A network according to claim 5, wherein said switch with at least two ports is replaced by an Ethernet card with at least two ports.

19. A network according to claim 6, wherein the protocol is arranged to prevent the creation of functionally non-terminated loops.

20. A network according to claim 8, wherein it further comprises one or more IED-devices adapted directly to the loop-shaped network and/or the control and data acquisition device using a switch.
